(19) United States
(12) Patent Application Publication
(10) Pub. No.: US 2011/0078848 A1
(43) Pub. Date: Apr. 7, 2011

(54) Treatment of Folded Articles

(76) Inventors: Michael P. Mathis, Powder Springs, GA (US); Stephen L. Kaplan, San Carlos, CA (US); Roger B. Quincy, III, Cumming, GA (US); Ali Yahiaoui, Roswell, GA (US)

(21) Appl. No.: 12/573,224

(22) Filed: Oct. 5, 2009

(51) Int. Cl. A62B 17/00; A41D 13/00; D06F 89/00; D01F 11/00

(52) U.S. Cl. 2/457; 223/37; 8/115.52

(57) ABSTRACT

The present invention is generally directed to a method of treating a folded garment to achieve good alcohol repellency on the innermost layers of the folded garment.

### BACKGROUND OF THE INVENTION

Protective garments provide a barrier which may prevent a wearer from contact with potential contaminants. A variety of such garments are used in applications such as medical and industrial applications to prevent the transmission of liquids and other contaminants through the garment to the wearer. Such garments may be generally loose fitting, with portions of the garment such as the wrist portions and ankle portions designed to fit closely and comfortably about the wearer.

The protective garment may be configured as a gown or coat having a main body portion to which sleeves are attached. Surgical gowns are an example of such protective garments that are designed to limit the transmission of fluids such as perspiration, blood, saliva, drugs and saline through the gown to either the wearer or the patient. The protective garment may also be configured as a unitary garment having an upper shirt portion and a lower trousers portion, such as a coverall. Many of these garments are manufactured from or include in their construction nonwoven materials and laminates of nonwoven materials. It is not always possible, however, to produce a fabric having all desired attributes for a given application. As a result, it is often necessary to treat fabrics to impart desired properties such as liquid repellency.

To achieve a desired level of liquid repellency, a fluorocarbon coating may be applied to the nonwoven material prior to the material being formed into the protective garment. For example, a treatment composition may be applied topically or internally to the nonwoven material. As the garment is constructed from the nonwoven material, those portions of nonwoven material which are not utilized include the additional coating or internal additive, which is costly and wasteful. Additionally, techniques used in garment construction can negatively impact barrier properties. For example, attaching a sleeve onto a main body of the garment by sewing creates holes which may, if not adequately addressed, diminish the barrier properties of the garment in the seam area.

As such, there remains a need for garments to provide excellent barrier protection as well as other properties, while enhancing manufacturing efficiencies in the production of such garments.

### SUMMARY OF THE INVENTION

The present invention is generally directed to a method for treating a folded garment, such garments including gowns, lab coats and unitary garments. The invention is also directed to folded garments which are treated by such methods. These garments may be formed of a fabric layer having opposite exposed faces.

More particularly, the method of the present invention is directed to treating a folded garment to improve its repellency in an efficient and effective manner. The method includes the step of providing a garment in a folded configuration. In some embodiments, the garment may be folded along at least a first fold line, a second fold line and a third fold line. In this manner, the fabric layer is folded multiple times upon itself. In particular embodiments, the fabric layer may be folded so that at least ten fabric layers are contained within at least one cross-section of the folded garment. In other embodiments, more fabric layers may be contained within at least one cross-section of the folded garment. While any number of layers may be contained within at least one cross-section of the folded garment, fifteen or twenty or thirty fabric layers may be included in some embodiments. Some folded garments may include a fourth fold line that is substantially parallel to the first fold line, with the second and third fold lines intersecting the fourth fold line.

The fabric layer of which the folded garment is formed may include various suitable materials, such as woven and nonwoven materials. In some embodiments, the garment may include a nonwoven material. The nonwoven material may be formed from a polyolefin in selected embodiments.

The folded garment may be subjected to a plasma treatment to increase the alcohol repellency rating of the folded garment. The plasma process sufficiently applies an appropriate treatment throughout the folded garment to increase the alcohol repellency rating of the innermost fabric layers of the folded garment. While a variety of plasma treatment methods may be utilized, a radio frequency (RF) plasma treatment is adaptable to the present invention. A pulsed RF plasma treatment may be used in selected embodiments. The plasma treatment may be used to apply one or more fluoro-chemical monomers to at least a portion of the fabric via graft polymerization. While numerous fluoro-chemical monomers may be used, perfluorodecyl acrylate (“PFDEA”) may be particularly suitable for use in certain embodiments.

The innermost fabric layers of the folded garment may have an alcohol repellency rating of at least 7 after the plasma treatment in some embodiments. The innermost fabric layers may, in particular embodiments, have an alcohol repellency rating of 10 after the plasma treatment. At least a portion of the fabric layer may, in specific embodiments, have an alcohol repellency rating of 6 or less prior to such plasma treatment. After the plasma treatment, the innermost fabric layers may have an alcohol repellency rating that is at least 2 higher than the initial alcohol repellency rating. For example, if the initial alcohol repellency rating is 4, the final alcohol repellency rating after treatment would be 6. Similarly, if the initial alcohol repellency rating is 6, the final alcohol repellency rating after treatment would be 8. In other embodiments, the alcohol repellency rating of the innermost fabric layers of the folded garment is increased by at least 4 after treatment. In such an embodiment, the initial alcohol repellency rating could be 5 and the alcohol repellency rating after treatment would be 9.

Other features and aspects of the present invention are described in more detail below.

### BRIEF DESCRIPTION OF THE DRAWINGS

A full and enabling disclosure of the present invention, including the best mode thereof, directed to one of ordinary skill in the art, is set forth more particularly in the remainder of the specification, which makes reference to the appended figures in which:

FIG. 1 is a top view of a partially folded garment according to one embodiment of the present invention;

FIG. 2 is a top view of the garment of FIG. 1 in its fully folded configuration;

FIG. 3 is a top view of a partially folded unitary garment according to an embodiment of the invention;

FIG. 4 is a side view of the garment of FIG. 3 in its fully folded configuration;

FIG. 5 is a cross-sectional view of the folded garment in FIG. 4, taken along lines A-A;

FIGS. 6 through 8 illustrate a particular manner in which a gown may be folded;

FIG. 9 is a photograph of a section of treated nonwoven material onto which drops of various fluids have been placed;

FIG. 10 is a photograph of an untreated gown onto which drops of various fluids have been placed; and

FIG. 11 is a photograph of a sleeve of a gown which was treated in the folded condition and onto which drops of various fluids have been placed.

Repeat use of reference characters in the present specification and drawings is intended to represent same or analogous features or elements of the invention.

### DETAILED DESCRIPTION OF REPRESENTATIVE EMBODIMENTS

Reference now will be made in detail to various embodiments of the invention, one or more examples of which are set forth below. Each example is provided by way of explanation, not limitation of the invention. In fact, it will be apparent to those skilled in the art that various modifications and variations may be made in the present invention without departing from the scope or spirit of the invention. For instance, features illustrated or described as part of one embodiment, may be used on another embodiment to yield a still further embodiment. Thus, it is intended that the present invention cover such modifications and variations.

The present invention is generally directed to an improved process for treating a folded protective garment to obtain a desired level of repellency in an effective and efficient manner. The protective garment may be configured as a medical gown or lab coat having a main body portion to which sleeves are attached. The protective garment may also be configured as a unitary garment such as a coverall having an upper shirt portion and a lower trousers portion.

Such protective garments are commonly manufactured from fabrics such as woven and nonwoven webs, including nonwoven laminates. As used herein, the term “nonwoven web” refers to a web having a structure of individual fibers that are randomly interlaid, not in an identifiable manner as in a woven or knitted fabric. Nonwoven webs include, for example, meltblown webs, spunbond webs, carded webs, wet-laid webs, airlaid webs, coform webs, hydraulically entangled webs, etc. The basis weight of the nonwoven web may generally vary, but is typically from about 5 grams per square meter (“gsm”) to 200 gsm, in some embodiments from about 10 gsm to about 150 gsm, and in some embodiments, from about 15 gsm to about 100 gsm.

As used herein, the term “meltblown web” generally refers to a nonwoven web that is formed by a process in which a molten thermoplastic material is extruded through a plurality of fine, usually circular, die capillaries as molten fibers into converging high velocity gas (e.g. air) streams that attenuate the fibers of molten thermoplastic material to reduce their diameter, which may be to microfiber diameter. Thereafter, the meltblown fibers are carried by the high velocity gas stream and are deposited on a collecting surface to form a web of randomly dispersed fibers. Meltblown fibers may be substantially continuous or discontinuous, and are generally tacky when deposited onto a collecting surface.

As used herein, the term “spunbond web” generally refers to a nonwoven web containing small diameter substantially continuous filaments. The filaments are formed by extruding a molten thermoplastic material from a plurality of fine, usually circular, capillaries of a spinnerette with the diameter of the extruded filaments then being rapidly reduced as by, for example, eductive drawing and/or other well-known spunbonding mechanisms. Spunbond filaments are generally not tacky when they are deposited onto a collecting surface. Spunbond filaments may sometimes have diameters less than about 40 micrometers, and are often between about 5 to about 20 micrometers.

As noted above, protective garments are manufactured from fabrics such as nonwoven webs. Such fabrics include two opposite exposed faces and can be characterized as a single layer. Each single fabric layer may include a plurality of sub-layers. For example, an SMS/film laminate is a single fabric layer having two opposite exposed faces, the single fabric layer including a plurality of sub-layers. Specifically, the SMS film/laminate may be viewed as including two sublayers (an SMS sub-layer and a film sub-layer) or four sub-layers (two spunbond sub-layers, a meltblown sub-layer and a film sub-layer).

Protective garments may also include cuffs and collars produced from a variety of materials, such as nonwoven and woven materials. In particular, woven elastic cuffs which are available from Straus Knitting Mills, Inc. (St. Croix Falls, Wis.) may be utilized with the garments of the present invention.

When a garment is folded, the single fabric layers become stacked upon one another. If a cross-section of the garment was taken, it would show that an exposed face of a single fabric layer would be positioned adjacent to an exposed face of a different single fabric layer. In any given cross-section, there would be a plurality of single fabric layers having exposed faces positioned adjacent to each other.

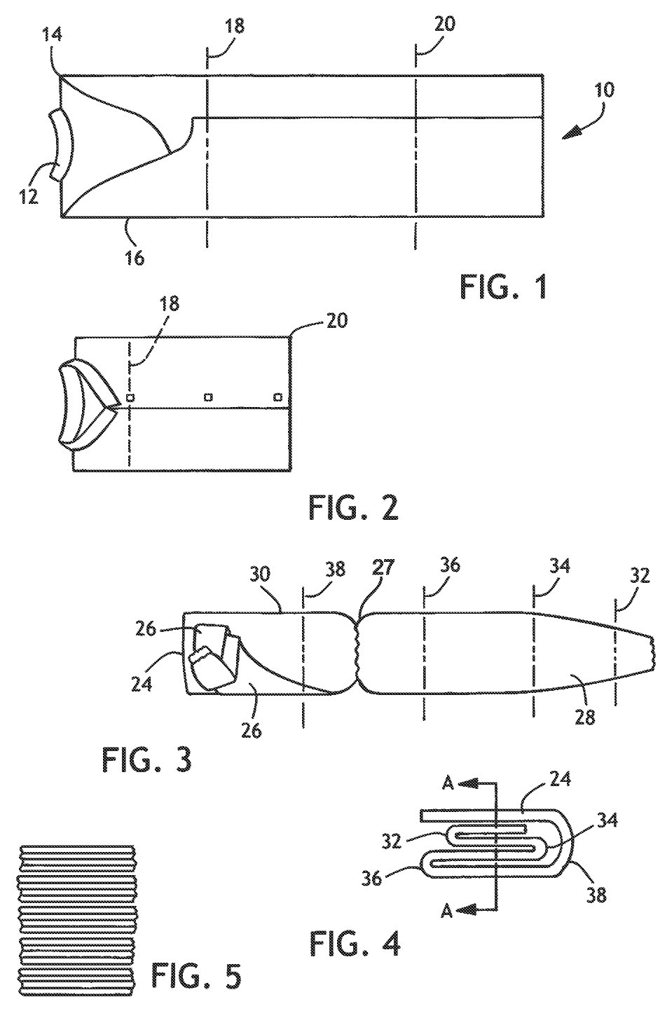

There are many different ways to fold protective garments. For example, a garment 10 having a collar 12, such as a lab coat, may be folded as shown in FIGS. 1 and 2. The sleeves (not shown) of the lab coat may be folded inwardly, and the garment folded into thirds along a first longitudinal fold line 14 and a second longitudinal fold line 16 which each extend along the length of the garment. As used herein, the “longitudinal” direction of a garment extends along a line from an upper portion of the wearer (such as the head or neck) to a lower portion of the wearer (such as the knees or feet). The “transverse” direction of a garment extends substantially perpendicular to the longitudinal direction of the garment.

As shown in FIG. 2, the partially folded garment may be folded along a third fold line 18 and a fourth fold line 20, which extend in a transverse direction to the first and second fold lines 14 and 16, respectively. As such, the third and fourth fold lines 18 and 20, respectively, intersect or cross the first and second fold lines 14 and 16, respectively.

In FIGS. 3 and 4, a unitary garment 24 that is suitable for use in various applications is shown. The unitary garment 24 includes an upper shirt portion having sleeves 26 and a lower trousers portion 28. Both the sleeves 26 and trousers 28 are gathered at the ends proximate to the user's wrist and ankles, as well as the waist portion 27 of the garment 24.

In FIG. 3, the garment 24 is shown folded in half longitudinally along a first fold line 30. The sleeves 26 are folded inwardly to lay upon the main body of the unitary garment. Various transverse fold lines are utilized to fold the garment into the configuration shown in FIG. 4. The second fold line 32 is positioned closest to the lower portion of the trousers 28. The third fold line 34 is positioned between the second fold line 32 and the upper portion of the garment. Similarly, the fourth and fifth fold lines 36 and 38 extend in the transverse direction and are positioned progressively closer to the uppermost portion of the garment 24. The garment 24 is folded along second and third fold lines 32 and 34, respectively, in an “s” configuration. At fourth fold line 36, the garment 24 is folded in the same direction as at the second fold line 32, permitting the entire garment 24 to be enclosed by the fifth fold line 38.

While the examples shown herein utilize fold lines which intersect in a substantially perpendicular manner, the folded garments useful in the present invention may be folded in any manner, utilizing any number of angled fold lines, which may or may not extend the full length or breadth of the garment.

FIG. 5 is a simplified cross-section taken along lines A-A in FIG. 4, illustrating an exemplary number of single fabric layers, each layer having two exposed faces, which may exist at a given position in the folded garment 24.

Most folding patterns will result in multiple irregular small folds and overlapping material which do not extend across the full width or length of the garment. In such situations, it is appropriate to count the irregular folds and overlapping material into the number of single fabric layers present in a given cross-section, as the process of the present invention should treat the exposed faces of the layers of the folded garment, even partial layers, to adequately treat the folded garment.

In certain instances, a cross-section may reveal a seam where the previously exposed faces of different fabric layers have been attached to each other. In such a situation, the seam would be viewed, for purposes herein, as forming a single fabric layer.

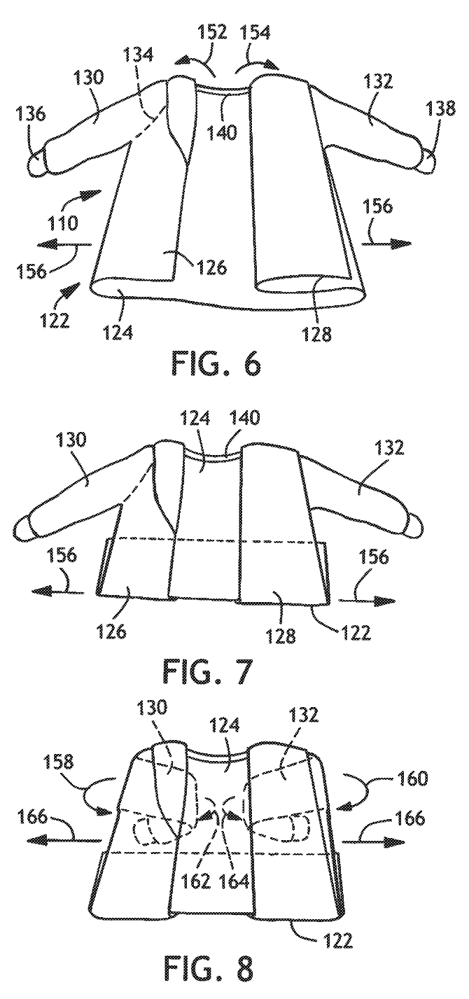

Surgical gowns may be folded in a ‘book fold’ configuration to assist in reducing the opportunities to contaminate the exterior surface of the gown during donning. As seen in FIG. 6, a gown 110 is shown lying substantially flat and includes a main gown 122 having a back portion 124 and an opposed front portion having left and right flaps 126 and 128, respectively. The back portion 124 is formed from a single fabric layer having two exposed opposite-facing surfaces. The left flap 126 also is formed from a single fabric layer having two exposed opposite-facing surfaces. When the left flap is folded, one exposed surface of the fabric layer which forms the back portion 124 in the area of the gown that is positioned closest to the lower edge of the garment is positioned adjacent to one exposed surface of the fabric layer which forms the left flap 126 in the area of the gown that is positioned closest to the lower edge of the garment.

The gown 110 may further include a pair of sleeves 130 and 132 having cuffs 136 and 138, respectively. A collar 140 may be stitched or otherwise attached to the upper portion of the main gown 122, if desired.

The gown 110 may be folded as illustrated in FIGS. 6-8. The flaps 126 and 128 are folded at least partially back upon themselves, as indicated at 152 and 154. As shown in FIG. 7, the main gown 122 may be folded back along a transverse fold line 156. In FIG. 8, the sleeves 130 and 132 are folded inward as indicated at 158 and 160, and outward at an intermediate location as indicated at 162 and 164. Alternatively, sleeves 130 and 132 may be folded only inwardly to cross one another. The main gown 122 may then be back folded along a transverse fold line 166, indicated in FIG. 8. A multitude of other folding patterns may also be utilized with the present invention.

The Worldwide Strategic Partners standard test number WSP 80.8 (05) entitled “Standard Test Method for Alcohol Repellency of Nonwoven Fabrics” may be used to determine the repellency of a garment. The test method measures the resistance of nonwoven fabrics to wetting and penetration by alcohol and alcohol/water solutions. Drops of standard test liquids, consisting of a selected series of water/alcohol solutions, are placed on the test material and observed for penetration or wetting. Any alcohol or alcohol/water solution specified in the test method may be used in accordance with the test method. The alcohol repellency rating is the highest numbered test liquid which does not penetrate the fabric within five minutes. If there is a conflict between the test as discussed in this document and the test specification, the test specification is to be followed.

Alcohol solutions having decreasing surface tensions with increasing alcohol concentrations are utilized in the test and are listed below in Table 1. The alcohol repellency rating determined in WSP 80.8 (05) serves as an estimate of the overall surface repellency of the test material.

TABLE 1
Standard Test Solutions

| | |
|---|---|
| Alcohol Repellency | Composition by Weight |

| Rating No. | Percent Alcohol | Percent Water |
|---|---|---|
| 0 | 0 | 100 |
| 1 | 10 | 90 |
| 2 | 20 | 80 |
| 3 | 30 | 70 |
| 4 | 40 | 60 |
| 5 | 50 | 50 |
| 6 | 60 | 40 |
| 7 | 70 | 30 |
| 8 | 80 | 20 |
| 9 | 90 | 10 |
| 10 | 100 | 0 |

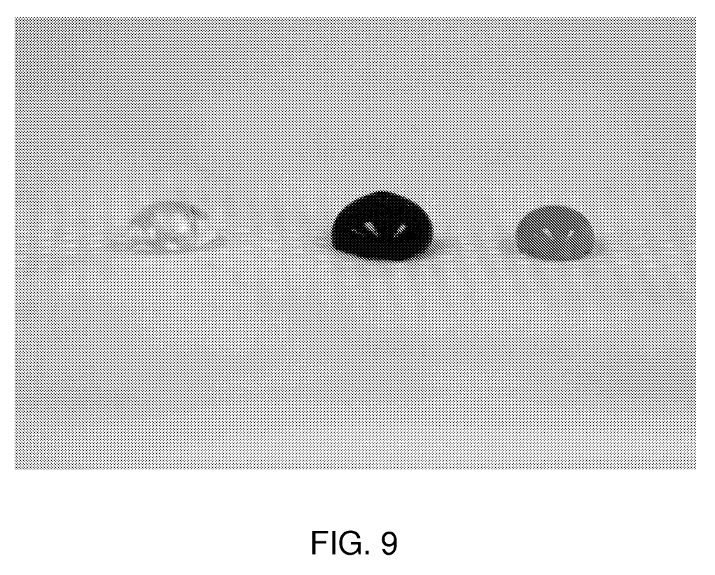

The alcohol repellency rating of the fabric is the highest numbered test liquid which will not penetrate the fabric within a period of five minutes. The garment will show complete resistance to penetration by a given test liquid, which is indicated by a spherical drop which shows no tendency to penetrate the garment, such as is shown in FIG. 9.

Liquid repellency can be achieved by subjecting a material to various treatments. Plasma treatments may be particularly suitable to increase the alcohol repellency of a material. Applying a fluorochemical to a fabric via plasma treatment is particularly suitable in the present invention. The level of liquid repellency achieved by plasma fluorination of a garment will depend, in part, upon the amount of fluorochemical that has been deposited and graft copolymerized on the surface of the garment. Various references are available which describe, in detail, plasma fluorination processes. For example, US 20030134515 and EP 1 557 489 disclose plasma fluorination processes. While a variety of plasma fluorination processes are available, the plasma fluorination processes used to treat folded garments for repellency to fluids in the examples of the present invention included generating plasma in a vacuum chamber using radio frequency (RF). A gas, such as, for example, a gas containing a monomer, is flash-evaporated into the chamber. The plasma initiates the graft polymerization of the monomer onto the surfaces of the garment, including pores, seams and stitching holes, that can be reached by the activated monomer chemistry.

Various monomer compounds may be used in the present invention, including, for example, fluorinated compounds. Exemplary fluorinated monomers include 2-propenoic acid, 2,2,3,3,4,4,5,5,6,6,7,7,8,8,8-pentadecafluorooctyl ester; 2-propenoic acid, 2-methyl-2,2,3,3,4,4,5,5,6,6,7,7,8,8,8-pentadecafluorooctol ester; 2-propenoic acid, pentafluoroethyl ester; 2-propenoic acid, 2-methyl-pentafluorophenyl ester; 2,3,4,5,6-Pentafluorostyrene; 2-Propenoic acid, 2,2,2-trifluoroethyl ester; and 2-propenoic acid, 2-methyl-2,2,2-trifluoroethyl ester. Other suitable monomers include those fluoroacrylate monomers having the general structure of:

CH₂═CROCO(CH₂)ₓ(CₙF₂ₙ₊₁)

wherein n is an integer ranging from 1 to 12, x is an integer ranging from 1 to 8, and R is H or an alkyl group with a chain length varying from 1 to 16 carbons. Specifically, perfluorodecyl acrylate, 1H,1H,2H,2H-heptadecafluorodecyl acrylate and 3,3,4,4,5,5,6,6,7,7,8,8,9,9,10,10,10-heptadecafluorodecyl methacrylate are also suitable for use in the present invention. In many instances, the fluoroacrylate monomer may be comprised of a mixture of homologues corresponding to different values of n. Monomers of this type may be readily synthesized by one of skill in the chemical arts by applying well-known techniques. Additionally, many of these materials are commercially available. Specifically, suitable fluoro-acrylic monomers include TG-10, TG-20 or TG-30, which are available from Daikin Americas, Inc. (Decatur, Ala.). If desired, perfluorodecyl acrylate may be utilized and is available from Apollo Chemical Company, LLC (Burlington, N.C.).

Exemplary processes useful in the present invention are described below and in Table 2. Each process carries a numeric designation and each step within the process carries a letter designation. Each process was carried out in a chamber having approximately 100 liters of active plasma.

TABLE 2

| | | | | | Duty Cycle | Duration of |
|---|---|---|---|---|---|---|
| Process | Step | Gas | Liquid | Power | (at 100 Hz) | Step (mins) |
| 1 | A | 30 sccm Argon | 15 ml/hr PFDEA | 100 watts | 0.5% | 10 |
| | B | 500 sccm Argon | None | 0 | n/a | 2 |
| 2 | A | 30 sccm Argon | 15 ml/hr PFDEA | 100 watts | 0.5% | 20 |
| | B | 500 sccm Argon | None | 0 | n/a | 2 |
| 3 | A | 30 sccm Argon | 17.5 ml/hr PFDEA | 100 watts | 0.5% | 20 |
| | B | 500 sccm Argon | None | 0 | n/a | 2 |

In Step A of Process 1, a reactor had been evacuated to about 10 millitorr. In general, the monomer reactor pressures employed range from about 1 millitorr to about 200 millitorr, although values outside this range may also be utilized. In some embodiments, the monomer reactor pressures may range from about 10 millitorr to about 100 millitorr, and in other embodiments from about 20 millitorr to about 50 millitorr.

An RF field was applied to electrodes which were positioned within the reactor, and a plasma was established to act as a charge carrier between the electrodes. Thirty (30) standard cubic centimeters (“sccm”) of argon was pumped into the chamber. PFDEA was also added to the chamber at a rate of fifteen (15) ml/hour. A power of 100 Hz was applied at a duty cycle of 0.5% for five minutes. The term “duty cycle” as used herein is the ratio of the plasma on time (i.e. discharge time) to a sum of the plasma-on time and the plasma-off time (i.e. non-discharge time). The fluoro-acrylic monomer was flash-evaporated and the plasma initiated the graft polymerization of the PFDEA onto the various surfaces of the folded garments.

In Step B of Process 1, 500 sccm of argon was fed into the reactor and was held in the reactor for two minutes, with the reactor in an unpowered condition. This step purged the chamber and brought the chamber to atmospheric pressure permitting access to the samples. The treated samples were removed from the plasma chamber and tested for liquid repellency.

In selected embodiments, the reaction time may vary from about 10 seconds to about 30 minutes or longer if necessary, depending on the size of the reactor and the number of garments inside the plasma reactor. Other fluorinated gases and fluorine precursors may also be used in the plasma treatment process.

As noted in Table 2, Process 2 differs from Process 1 in that Step A continued for twenty minutes. In Process 3, 17.5 ml/hr of PFDEA was added to the chamber in Step A for twenty minutes.

Two 17″ by 42″ sections of an SMS web were positioned adjacent to each other and folded 3 times, resulting in sixteen single fabric layers. This folded material was subjected to Process 1. Testing revealed that the sections of SMS were repellent to 100% in all areas and achieved an alcohol repellency rating of 10. A folded lab coat, manufactured of SMS and available from the Kimberly-Clark Corporation as Basic Plus Lab Coat was subjected to Process 1. All surfaces of the SMS achieved an alcohol repellency rating of 10, including the innermost fabric layers. A folded yellow gown, manufactured of SMS and available from the Kimberly-Clark Corporation as Yellow Control Cover Gown was also subjected to Process 1. The gown demonstrated an alcohol repellency rating of 10 within all folds and for all layers.

In FIG. 9, three drops have been placed onto a single layer of nonwoven fabric which was removed from a garment that was treated in the folded condition. The left-most drop, which is clear, is 100% isopropyl alcohol. The center drop, which is the darkest colored drop of the three drops, is Betadine® solution. The third and right-most drop, which is shown as grey in FIG. 9, is 70% isopropyl alcohol, 30% water and a negligible amount of a dye. All three drops show no penetration into the treated fabric after five minutes, and achieve an alcohol repellency rating of 10.

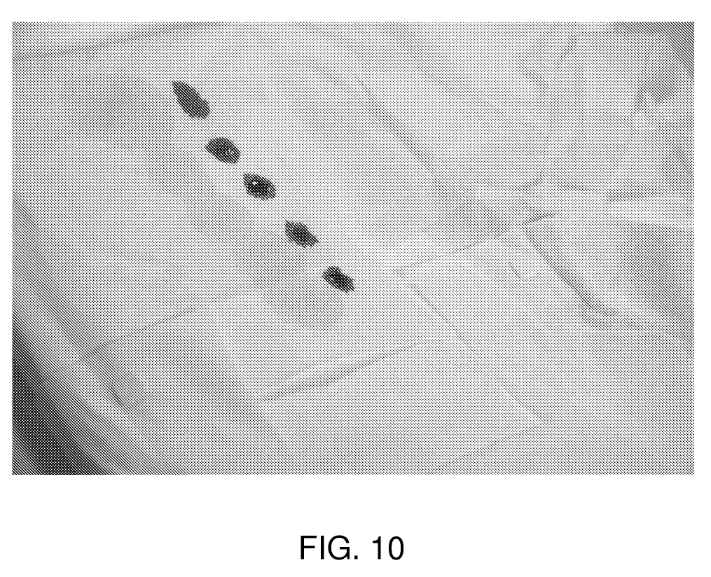

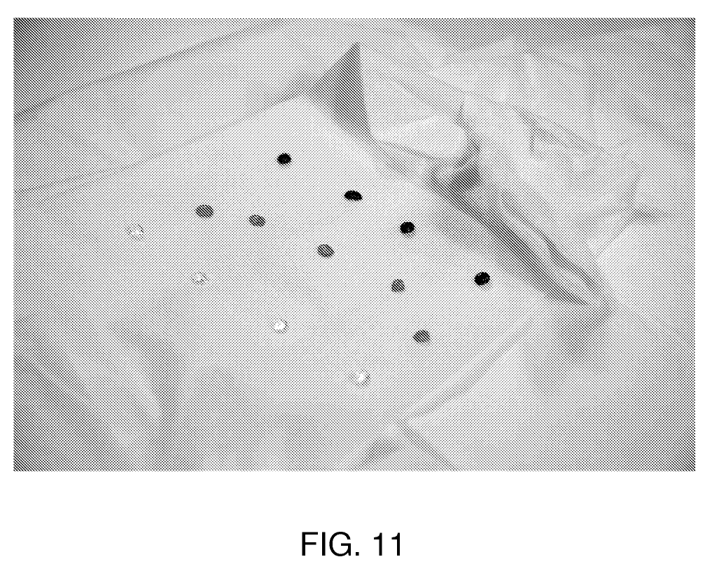

In contrast, FIG. 10 shows a partially unfolded untreated garment onto which five drops of Betadine® and five drops of 70% alcohol/30% water have been placed. All drops have substantially penetrated the garment material within five minutes. FIG. 11 shows a partially unfolded garment which was subjected to a treatment according to the present invention while the garment was in a folded condition. In the particular folded condition, the sleeves of the garment were positioned near the innermost portion of the folded garment. The garment was unfolded and drops of various liquids were placed on the sleeve. The right-most darkest-colored drops are Betadine® solution, which show no penetration into the garment sleeve after five minutes. The central row of five drops, which show up as grey in FIG. 11 consist of 70% alcohol/30% water and similarly show no penetration into the garment sleeve after five minutes. The left-most drops, which are clear, are 100% alcohol and show no penetration into the garment sleeve after five minutes.

While the invention has been described in detail with respect to the specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto.

What is claimed is:

1. A method for treating a folded garment comprising:
providing a garment in a folded configuration, the garment made of a fabric layer having opposite exposed faces, at least a portion of the fabric layer having an alcohol repellency rating of 6 or less, the garment being folded along at least a first fold line, a second fold line and a third fold line, the second and third fold lines intersecting the first fold line, wherein the fabric layer is folded multiple times upon itself when the garment is in the folded configuration; and
subjecting the folded garment to a plasma treatment that penetrates the garment in its folded configuration such that the three innermost fabric layers of the folded garment have an alcohol repellency rating of at least 7.

2. The method of claim 1, the folded configuration of the garment causing the fabric layer to be folded multiple times upon itself so as to define at least ten fabric layers within at least one cross-section of the folded garment, wherein each of the at least ten fabric layers in the at least one cross-section remains unattached to and separable from the exposed faces of adjacent fabric layers in the cross-section.

3. The method of claim 2, the fabric layer being folded multiple times upon itself so as to define at least twenty fabric layers within at least one cross-section of the folded garment, wherein each of the at least twenty fabric layers in the at least one cross-section remains unattached to and separable from the exposed faces of adjacent fabric layers in the cross-section.

4. The method of claim 1, the garment being folded along a fourth fold line, at least a portion of the fourth fold line being substantially parallel to the first fold line, and the second and third fold lines intersecting the fourth fold line.

5. The method of claim 1, the three innermost single fabric layers of the folded garment having an alcohol repellency rating of 10.

6. The method of claim 1, the fabric layer including a nonwoven material.

7. The method of claim 6, the nonwoven material comprising a polyolefin.

8. The method of claim 1, the three innermost fabric layers having fluoro-chemical monomer graft polymerized onto at least a portion of each of the fabric layers.

9. A folded garment treated by the method of claim 1.

10. The method of claim 1, the plasma treatment being a radio frequency pulsed plasma treatment.

11. A method for treating a folded garment comprising:
providing a garment in a folded configuration, the garment made of a fabric layer having opposite exposed faces, the garment being folded along at least a first fold line, a second fold line and a third fold line, the second and third fold lines intersecting the first fold line, wherein the fabric layer is folded multiple times upon itself when the garment is in the folded configuration so as to define at least 15 fabric layers within at least one cross-section of the folded garment, wherein each of the at least 15 fabric layers in the at least one cross-section remains unattached to and separable from the exposed faces of the adjacent fabric layers in the cross-section; and
subjecting the folded garment to a plasma treatment that penetrates the garment in its folded configuration such that a fluoro-chemical monomer is graft polymerized onto at least a portion of each of the fabric layers, the alcohol repellency rating of the innermost fabric layers of the folded garment being increased by at least 2.

12. The method of claim 11 wherein the alcohol repellency rating of the innermost fabric layers of the folded garment is increased by at least 4.

13. The method of claim 11 wherein the alcohol repellency rating of the fabric layer of the folded garment after subjecting the garment to the plasma treatment is 10.

14. The method of claim 11, the fluoro-chemical monomer graft polymerized onto at least a portion of each of the fabric layers being perfluorodecyl acrylate.

15. A folded garment treated by the method of claim 11.
